(19) United States
(12) Patent Application Publication
(10) Pub. No.: US 2018/0143143 A1
(43) Pub. Date: May 24, 2018

(54) SYSTEM AND METHOD FOR INSPECTING BOTTLES AND CONTAINERS USING LIGHT

(71) Applicant: INDUSTRIAL DYNAMICS COMPANY LTD., Torrance, CA (US)

(72) Inventor: LEON COETZEE, Torrance, GA (US)

(73) Assignee: INDUSTRIAL DYNAMICS COMPANY LTD., Torrance, CA (US)

(21) Appl. No.: 15/572,724

(22) PCT Filed: May 7, 2016
(86) PCT No.: PCT/US16/31387

§ 371 Date: Nov. 8, 2017

Related U.S. Application Data
(60) Provisional application No. 62/158,828, filed on May 8, 2015.

(51) Int. Cl. G01N 21/90; G01N 21/88

(52) U.S. Cl. CPC G01N 21/9036; G01N 2021/8887; G01N 2021/8812; G01N 21/8806

(57) ABSTRACT

A device, system and method for inspecting containers by detecting a reflected light beam are described. A light source emits a directed light beam through a container. One or more cameras are oriented to detect and measure portions of the directional light beam reflected by one or more fragments contained within the container.

### FIELD OF TECHNOLOGY

This application relates generally to inspection of bottles and containers. More particularly, the disclosure relates to bottle or container inspection involving a directional light beam or a light source to indicate defects or commercial variations.

### BACKGROUND

Beverages that are contained within bottles are produced, purchased, and consumed daily. Since these beverages are consumer products, they are subject to rigorous quality control and inspection requirements, which are often performed directly on the containers while on production lines. The production process includes various functions, such as washing the bottle, inspecting the containers for defects, filling the bottle with a beverage, e.g., soda or beer, applying a closure, and labeling the bottle. Quality inspection of the filled-container occurs when the bottles run single-file, at the outfeed of the filler or in-feed or out-feed of the labeling machine. The single-file sections of many production lines are limited in distance and therefore are incapable of accommodating all possible inspection components due to space constraints, container handling issues, and the like.

### SUMMARY

This application describes a device, method and system and method for inspecting bottles or containers to detect defects by utilizing a directional light beam. The device, system and method disclosed herein can provide a bottle inspection component that performs multiple inspection functions, in a smaller footprint than that of current systems.

An aspect of this application relates to a system for inspecting a bottle. The system includes a filler component that fills the bottle with a liquid and a labeling component that labels the bottle. The system further includes an inspection component on an outfeed end of the filler and either outfeed or in-feed of labeling components. The inspection component includes a light source that generates a directional light beam and a camera or cameras that detect a portion of the directional light beam that is reflected by a fragment within the bottle.

The inspection component may include reflective structures that reflect and concentrate the reflected portions of the directional light beam. The reflected portion of the directional light beam may engage two reflective structures prior to reaching a camera. The inspection component may also include a means to convey the bottle over the light source or a dead plate (optional). Furthermore, the inspection component may have one or many illumination sources either continuous or strobed or combinations thereof. Moreover, the inspection component may include support belts that guide the bottle into an inspection position. Additionally, the inspection component may include a conveyor belt system having a length less than about 1200 mm. Two boxes, each containing a camera, may be included within the inspection component, which may hinge away from the conveyer for access. Additional cameras may be oriented within the inspection component to perform other detections, such as fill level detection, floating object and sinking object inspection, and bubble detection. The camera of the inspection component may be offset about 20 degrees from horizontal and/or about 70 degrees from an axis of the directional light beam. The directional light beam may have a diameter substantially equal to that of an inner diameter of the bottle.

Another aspect of this application relates to a method for inspecting a bottle. The method includes maneuvering, using a conveyor belt and support belts, a bottle into an inspection position. The inspection position is proximate a light source. The method further includes emitting a directional light beam from the light source. Moreover, the method includes detecting, using a camera, a portion of the directional light beam reflected by a fragment within the bottle.

The directional light beam may be transmitted through a base of the bottle toward a neck portion of the bottle. Furthermore, the bottle may be maneuvered onto a dead plate with one or more apertures or adjustable apertures. The directional light beam may have a diameter less than an inner sidewall diameter of the bottle. The directional light beam may be laser diodes or infrared source or another type of light source (e.g., Xenon strobe, Tungsten, Quartz Halogen, laser, visible, UV, IR, etc.).

A further aspect of this application relates to an inspection component for use within a system for inspecting a bottle or a container. The inspection component includes a directed light source that emits a directional light beam and at least two cameras positioned to detect a portion of the directional light beam that is reflected by a fragment of a bottle. The inspection component also includes reflective structures positioned to reflect and concentrate the reflected portion of the directional light beam prior to the portion of the directional light beam reaching a camera lens.

### BRIEF DESCRIPTION OF THE DRAWINGS

The features, nature, and advantages of this application will become more apparent from the detailed description set forth below when taken in conjunction with the drawings in which like reference characters identify corresponding aspects throughout.

FIGS. 1A through 1D illustrate observed bottle fragments.

FIG. 1E illustrates a bottle without fragments observed using the system and method.

FIG. 2 illustrates an inspection component of the system for detecting bottle fragmentation including a bottle not containing a fragment.

FIG. 3 illustrates an inspection component of the system for detecting bottle fragmentation including a bottle containing a fragment.

FIG. 4 illustrates an inspection component of the system for detecting bottle fragmentation.

FIGS. 5A through 5C illustrate an inspection component of the system for detecting bottle fragmentation.

FIGS. 6A through 6C illustrate the independence of color on the system for detecting bottle fragmentation.

FIGS. 7A through 7B illustrate use of the system for detecting bottle fragmentation to perform fill level and foam inspection.

FIGS. 8A through 8B illustrate use of the system for detecting bottle fragmentation to perform floating object and sinking object inspection.

FIG. 9 illustrates use of the system for detecting bottle fragmentation to perform bubble inspection, indicative of interior bottle surface cracks and imperfections.

FIG. 10 illustrates a process flow diagram of a method for inspecting a bottle.

### DETAILED DESCRIPTION

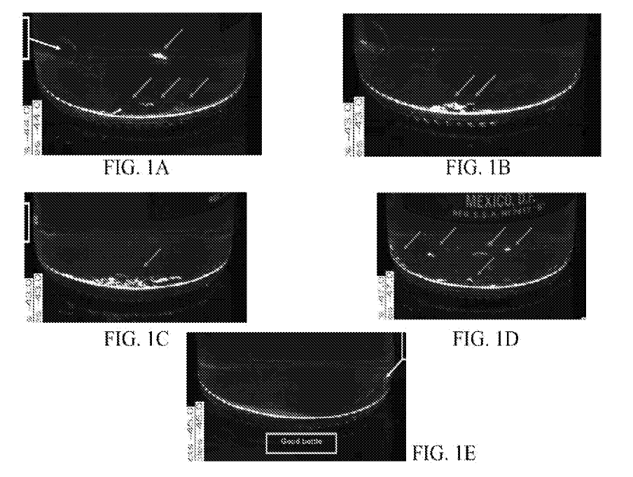

This application includes a system and a method for detecting fragmentation (e.g., glass fragmentation) and other defects within containers. A container has a bottom/base and a side wall. A mouth opening is located opposite the base. For example, glass fragments can occur at two locations, namely the filler and the crowner of a bottle. Filler fragments may be introduced during the filling process and may settle at the lowest part of the base of the bottle. The turbulence from the filling process often causes these fragments to bunch up, thereby resulting in groups of between 4 and 10 fragments. These fragments are often small in size, e.g., 2 mm×2 mm×2 mm or smaller. Crowner fragments may be introduced during the crowning process. They usually occur in groups of 1 to 2. They are often arced shaped, and measure 1.5 mm×1.5 mm×6 mm. These may exhibit large surface area to volume ratios and temporarily float on the top of foam, or at the fill-level of the liquid within the bottle. They may also sink to the base of the bottle. A variety of different fragments detected using the system and method disclosed herein are illustrated in FIGS. 1A through 1D and a “good” bottle without fragments is evidenced in FIG. 1E.

One embodiment makes use of a light pipe effect that is created, which starts at the base of the bottle and projects through to the neck area of the bottle. Rays of light reflected from the bottle liquid interface extend at unique or different angles, and commercially relevant variations in the bottle can be identified by analyzing reflection angle and intensity of the reflected light received by the cameras. The determination may be facilitated by imaging software with pattern recognition functionality, or by any other suitable software and/or techniques. The light pipe effect is configured to illuminate from the base of the bottle with a directed light source that cannot be detected by a strategically positioned camera when the light pipe effect is used on a bottle with no fragments.

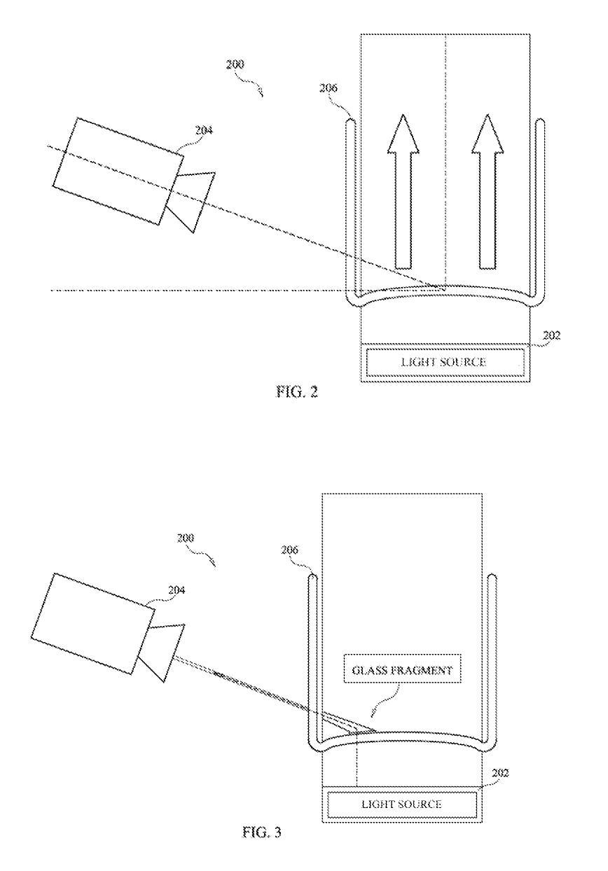

FIG. 2 illustrates an inspection component 200 for detecting glass fragmentation in a bottle 206. The bottle 206 does not contain fragments. The inspection component 200 includes a light source 202 and a camera 204.

The light source 202 generates a directional light beam along an axis. The light source 202 is capable of emitting directional light beams of varying wavelengths and amplitudes. As illustrated, the directional light beam is directed along the vertical dotted line. However, it should be appreciated by one skilled in the art that the light source 202 may be oriented to emit the directional light beam at angles other than vertical. The light source 202 may be a Flat panel LED strobe system, or any other light source known in the art that performs the functions and produces the results described herein. For example, the light source 202 may emit at various wavelengths (such as InfraRed), the light source 202 may also be formed from laser diodes, light sources coupled with optics, mirrors and the like.

The bottle 206 is positioned above the light source 202, within the directional light beam's path such that the base of the bottle 206 is at or proximate the light source 202 and the neck of the bottle 206 is distal from the light source 202 as compared to the base. In other words, the bottle 206 is positioned within the directional light beam's path such that a central axis of the bottle 206 that runs through the center of the bottle's base and the center of the bottle's opening is parallel with the axis of the directional light beam. A directed source of light can be achieved through, e.g., a diffuse light source stood-off from an aperture, which is placed in close proximity to the bottle base or a lens or mirror system to direct illumination towards the bottle base with or without an aperture to produce a sharp cut-off of light at the edge of the beam. The bottle 206 may be any glass or plastic bottle. For example, a non-limiting list of potential bottles 206 includes beer and soft drink bottles, and non-returnable and returnable bottles. When the bottle 206 is positioned within the light source or directional light beam, a curve, e.g., a white curve, is produced on the bottle 206 where the inner sidewall of the bottle 206 meets the base of the bottle 206. The directional light beam's diameter may be substantially equal to the inner sidewall diameter of the bottle 206, i.e., marginally less than the inner sidewall diameter of the bottle 206. This could also be achieved by variability in the light source. In this arrangement, a single light source may be used at a time to avoid interference in the reflected or refracted light signals or color variation signals. In yet another arrangement, the diameter of the light source may be sharply limited by an aperture or iris. If and when the bottle's size or shape is changed, the illumination source may be altered dynamically (e.g., through aperture controlled light) or statically.

The camera 204 can be oriented to face the base of the bottle 206. Furthermore, the camera 204 is offset with respect to horizontal or the axis of the emitted light. For example, the camera 204 may be located at an angle of about 20 degrees from horizontal. In other words, the camera 204 may be located at an angle of about 70 degrees from the axis of the emitted light. This allows the camera 204 to detect light reflected by fragments within the bottle 206.

FIG. 3 illustrates the inspection component 200 for detecting glass fragmentation in the bottle 206, wherein the bottle 206 contains a fragment. When the bottle 206 does not contain a fragment, the emitted light generated by the light source 202 passes through the bottle 206, no reflection (as illustrated in FIG. 2). However, when the bottle 206 contains a fragment located within the directional light beam's path, the fragment reflects at least a portion of the directional light beam, thereby resulting in the reflected portion being captured and measured by the camera 204. As discussed further, the position of the aperture, the size of the aperture, or shape of the aperture or iris can be optimized to allow an amount of light using simulations or other types of modeling.

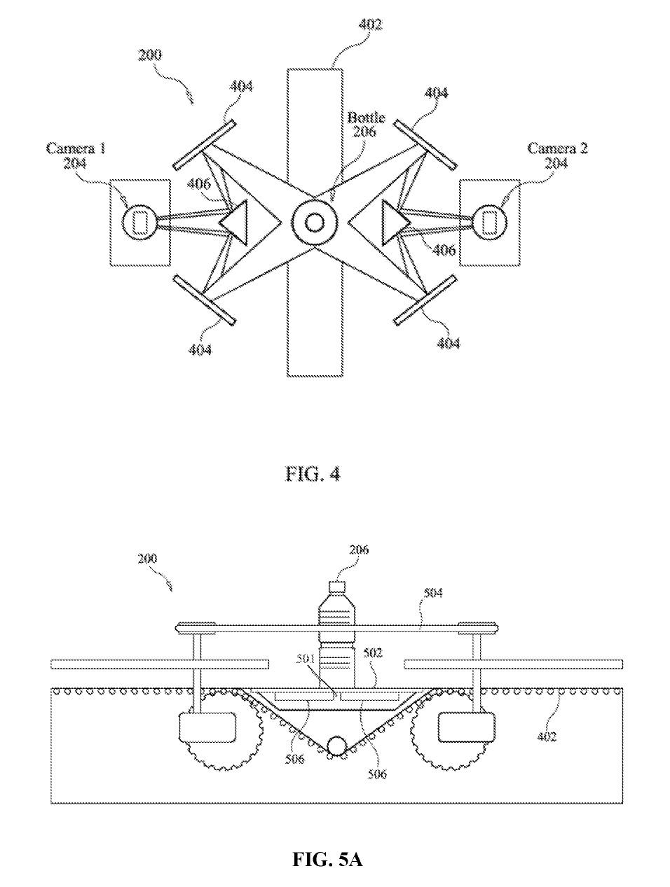

FIG. 4 further illustrates the inspection component 200 for detecting fragmentation within a bottle 206. The bottle 206 is located on a conveyor belt 402 that maneuvers the bottle 206 into the inspection component, which is on the outfeed end of the filler and infeed or out-feed end of labeler components of a beverage production system. Optimization of the inspection component 200 may involve ensuring that the defect of the bottle 206 is always capable of reflecting at least a portion of the directional light beam toward a camera 204. Therefore, more than one camera 204 may be utilized. As depicted, these cameras 204 may be located on a single plane on opposite sides of a bottle 206. The cameras 204 may be oriented at different angles with respect to each other and the bottle 206 without departing from the scope of This application.

The inspection component 200 may further include reflective structures 404, 406 that reflect and concentrate the reflected portion of the directional light beam as it moves from the bottle 206 to a camera 204. As depicted, the reflective structures 404, 406 are planar or triangular structures having planar surfaces. However, reflective structures 404, 406 with other geometric structures and non-planar, i.e., convex and concave, surfaces may be utilized. The reflective structures 404, 406 may be configured into a dual image mirror system wherein each reflected portion of the directional light beam engages two reflective structures 404, 406 prior to being measured by a camera 204. However, each beam of light may engage more or less than two reflective surfaces prior to being measured by a camera 204.

Moreover, the inspection component 200 may include a water sprayer(s) or air knives (not illustrated) located upstream of the filler and/or labeler components (not illustrated), i.e., located between the filler/labeler components and the inspection component 200. This allows for excessive chain lubrication to be eliminated or mitigated from the conveyor belt 402, which if present at the time of inspection may inhibit fragment detection as disclosed herein. For example, a linear water sprayer may be utilized.

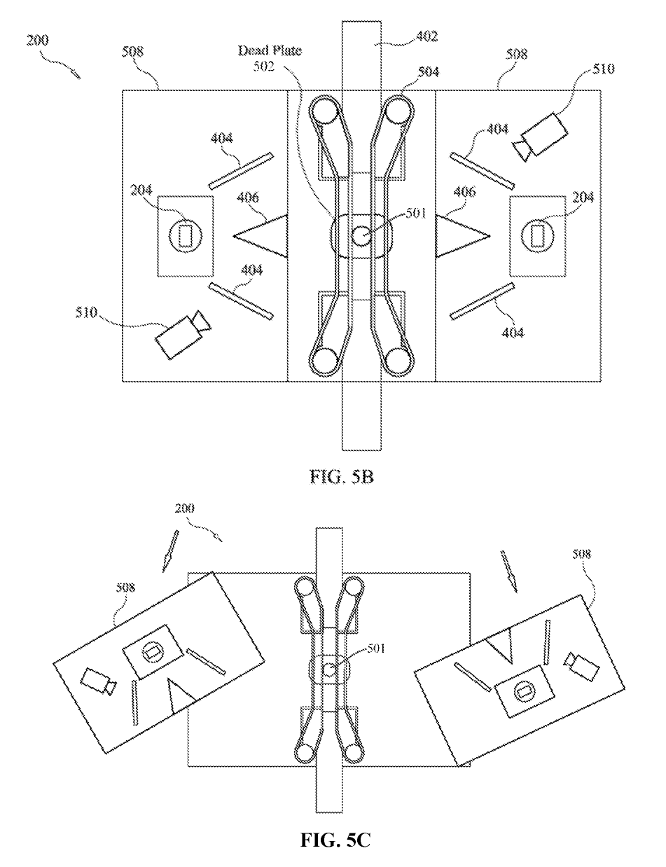

FIGS. 5A through 5C further illustrate aspects of the inspection component 200. The inspection component 200 may additionally include a dead plate 502, permitting the bottle 206 to slide utilizing its forward momentum (un-powered by a drive element) which minimizes mechanical bottle contact by the system, maximizing safety due to minimized handling of high pressure bottles 206. Any dead plate 502 known in the art may be utilized. The dead plate 502 may be, for example, 300 mm long and may accommodate a pair of base strobes 506. The position of the aperture or iris 501, the size of the aperture or iris 501, or shape of the aperture or iris 501 can be optimized to allow an amount of light using simulations or other types of modeling.

Moreover, the inspection component 200 may include support belts 504 that guide the bottle 206 into position to be inspected, and also address a deceleration component of the dead plate 502. The support belts 504 may be driven by aspects of a conveyer belt system, such as a conveyor chain. The total length of the conveyor belt system within the inspection component may be less than about 1200 mm. The belts may also convey the bottle over the illumination source, eliminating contact between the bottle and the source and/or dead plate.

Furthermore, the inspection component 200 may include two rotating camera boxes 508 that allow for easy maneuverability of the inspection component 200 and also allow for components of the inspection component 200 to be easily fixed/replaced. Additional cameras 510 may be utilized within the inspection component 200 to accommodate additional detections, such as floating object detection, fill level measurement, foam fill-level compensation, cap inspection, label inspection, and the like.

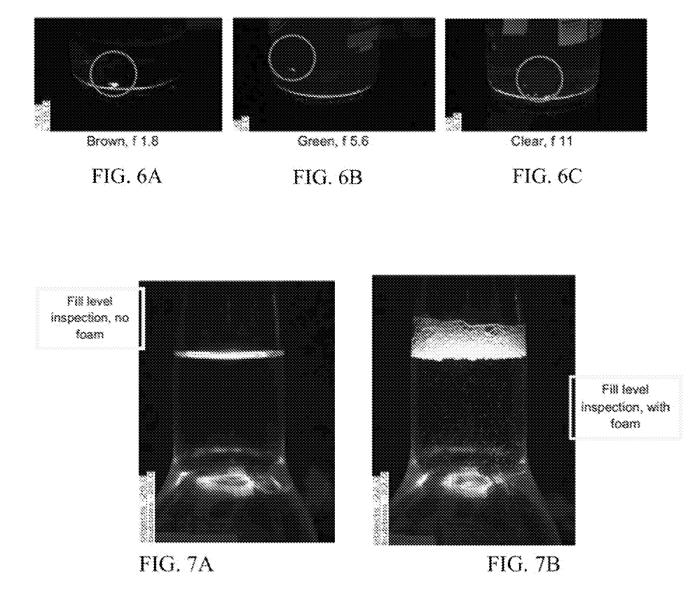

FIGS. 6A through 6C illustrate the impact of bottle color on the detection of bottle fragmentation. FIG. 6A depicts the use of a brown bottle; FIG. 6B depicts the use of a green bottle; and FIG. 6C depicts the use of a clear bottle. To depict the impact of bottle color upon the detection of fragments, the same shutter speed and strobe on-time were used to gather the images contained within FIGS. 6A through 6C. The shutter speed used was 1 ms. However, other shutter speeds may be utilized to detect fragments according to this application. Each differentiated colored area within the red circle of each respective FIG. is a fragment (e.g., glass fragment). Color or white/black contacts may be utilized to detect fragments without departing from the scope of this application.

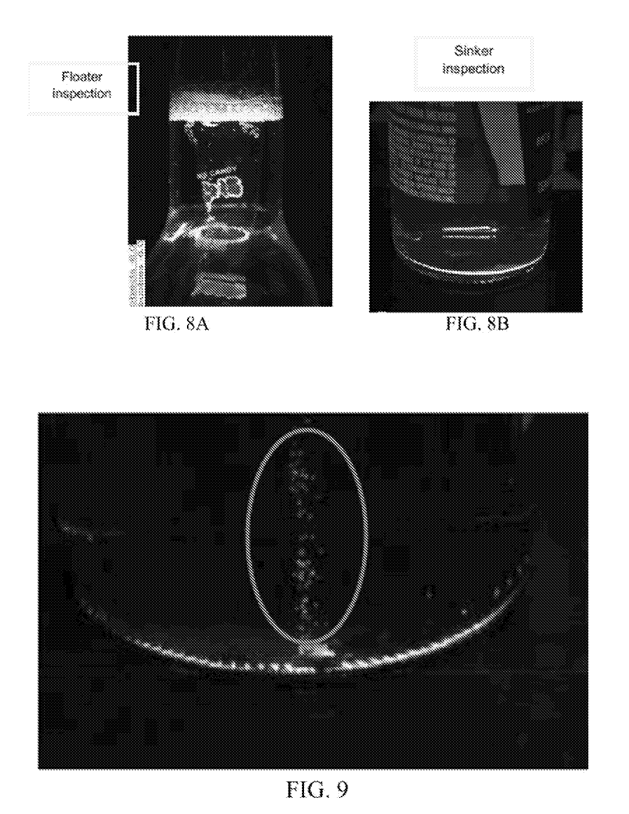

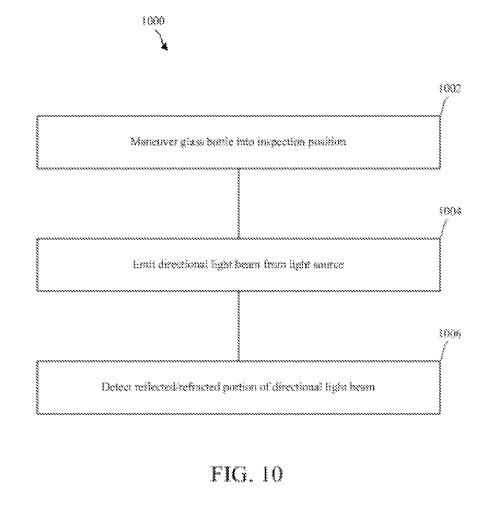

The inspection component 200 disclosed herein may be further utilized in other applications. Illuminating the base of a bottle allows for fill level inspection to be observed (illustrated in FIGS. 7A and 7B). Moreover, the inspection component 200 may further be used to conduct floating and sinking foreign object inspection (illustrated in FIGS. 8A and 8B respectively). Additionally, the inspection component 200 may be utilized to conduct bubble detection (illustrated in FIG. 9).

FIG. 10 illustrates a method 1000 for inspecting a bottle. A conveyor belt and support belts maneuver a bottle into an inspection position proximate a light source (illustrated as block 1002). The bottle may be maneuvered onto a dead plate. The inspection position may involve a base of the bottle being proximate the light source and an opening of the bottle being distal from the light source. A directional light beam is emitted from a light source (illustrated as block 1004). The directional light beam may be emitted through a base of the bottle toward a neck portion of the bottle. The directional light beam may have a diameter less than an inner sidewall diameter of the bottle. The directional light beam may be a laser, focused LED, incandescent light, fiber optic transmitter, or other source. Using a camera, a portion of the directional light beam reflected by a fragment within the bottle is detected (illustrated as block 1006). It is also possible to utilize electronic sensors instead of or in supplementation of cameras.

Although this application and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from this application, processes, machines, manufacture, compositions of matter, means, methods, or steps presently existing or later to be developed that perform substantially the same functions or achieve substantially the same result as the corresponding configurations described herein may be utilized according to This application. Accordingly, the appended claims are intended to include within their scope such processes, machines, manufacture, compositions of matter, means, methods, or steps.

1. An inspection system for optically examining a container, comprising:
an inspection component including:
a light source that generates light through the container; and
a light sensing element that detects a portion of the light reflected by a defect within the container;
wherein the light source and light sensing element are arranged such that the light sensing element receives the portion of the light reflected by the defect, the light source is directed through the container so to create a piping effect in rays of the light are generally parallel through the container from the bottom of the container, and the light has a diameter substantially equal to that of an inner diameter of the container.

2. The system as claimed in claim 1, wherein the light sensing element is a camera or a sensor.

3. The system as claimed in claim 1, wherein the light is directional light.

4. The system as claimed in claim 3, wherein the inspection component further includes reflective structures to produce directional light.

5. The system as claimed in claim 4, wherein the portion of the light reflected by the defect engages at least one reflective structure prior to reaching the camera.

6. The system as claimed in claim 4, further comprising a dead plate with at least one aperture.

7. The system as claimed in claim 1, further comprising an adjustable aperture.

8. The system as claimed in claim 1, further comprising a static aperture.

9. The system as claimed in claim 6, further comprising an aperture at a base of the container.

10. The system as claimed in claim 1, wherein the inspection component further includes at least one movable enclosure, the movable enclosure containing a camera.

11. The system as claimed claim 9, wherein the container is moved using belts, star wheels, guide rails or combinations thereof.

12. The system as claimed in claim 11, wherein the inspection component further includes cameras oriented to perform fill level detection, floating object inspection, sinking fragment inspection, cap, label and bubble detection and combinations thereof.

13. The system as claimed in claim 1, wherein light rays from the light source are less than 45 degrees from horizontal when the light sensing element is oriented down towards the container.

14. The system as claimed in claim 11, wherein the light has a diameter substantially equal to that of an inner diameter of the container.

15. A method for inspecting a container comprising the steps of:
maneuvering a container into an inspection position, the inspection position being proximate a light source, wherein the maneuvering step includes the inspection position involving a base of the container being proximate the light source and an opening of the container being distal from the light source
emitting a directional light beam from the light source, the light beam being directed through the bottom of the container to create a piping effect resulting in rays of the light being generally parallel through the container from a bottom of the container; and
detecting, using a light detection device, a portion of the directional light beam reflected by a fragment within the container.

16. The method as claim in claim 15, wherein the emitting step includes the directional light beam being emitted through a base of the container toward a neck portion of the container.

17. The method as claimed in claim 16, wherein the maneuvering step includes maneuvering the container onto a dead plate.

18. The method as claimed in claim 17, wherein the emitting step includes the directional light beam having a diameter less than an inner sidewall diameter of the container.

19. The method as claimed in claim 18, wherein the emitting step includes the directional light beam including one of laser diodes or infrared, and the liquid interface providing the beam reflection.

20. An inspection component for use within a system for inspecting a container comprising:
a directed light source that emits a directional light beam to create a light piping effect through the container;
at least one camera positioned to detect a portion of the directional light beam reflected by a defect of the container;
reflective structures positioned to reflect and concentrate the reflected portion of the directional light beam prior to the portion of the directional light beam reaching a camera; and
a dead plate with at least one aperture;
wherein the light source and the camera are arranged such that the light sensing element receives the portion of the light reflected by the defect, the light source is directed through the container so to create a piping effect in rays of the light are generally parallel through the container from the bottom of the container, the light has a diameter substantially equal to that of an inner diameter of the container, and light rays from the light source are less than 45 degrees from horizontal when the light sensing element is oriented down towards the container.
